(19) United States
(12) Patent Application Publication
(10) Pub. No.: US 2014/0174712 A1
(43) Pub. Date: Jun. 26, 2014

(54) COOLING CONTROL METHOD AND SYSTEM FOR BATTERY

(71) Applicant: HYUNDAI MOTOR COMPANY, Seoul (KR)

(72) Inventors: Hui Tae Yang, Seoul (KR); Hyun Soo Park, Anyang (KR); Suk Hyung Kim, Gunpo (KR); O Young Ahn, Hwaseong (KR)

(73) Assignee: Hyundai Motor Company, Seoul (KR)

(21) Appl. No.: 13/828,935

(22) Filed: Mar. 14, 2013

(30) Foreign Application Priority Data
Dec. 24, 2012 (KR) 10-2012-0152306

(51) Int. Cl. H01M 6/50; H01M 10/50

(52) U.S. Cl. CPC H01M 6/5038; H01M 10/5004
USPC 165/287

(57) ABSTRACT

Disclosed is a cooling control method and system for a battery. The cooling control method includes measuring, by a controller, an exterior temperature of a vehicle and a temperature of a battery. When the exterior temperature of the vehicle exceeds a first temperature, the method includes setting, by the controller, a cooling reference temperature based on the temperature of the battery and the exterior temperature. Furthermore, the method includes cooling, by the controller, the battery by adjusting the intensity of a cooling fan based on the set cooling reference temperature to prevent the temperature of the battery upon termination of cooling from exceeding a second temperature.

### CROSS REFERENCE

This application claims under 35 U.S.C. §119(a) the benefit of Korean Patent Application No. 10-2012-0152306 filed on Dec. 24, 2012, the entire contents of which are incorporated herein by reference.

### BACKGROUND OF THE INVENTION

1. Field of the Invention

The present invention relates, in general, to a cooling control technology for a battery, and more particularly, to a cooling control method and system for a battery, in which, when the exterior temperature reaches a predetermined threshold, cooling control of the battery is performed by adjusting a cooling fan when a rise in the temperature of the battery caused by the exterior temperature is detected, to cause the temperature of the battery upon termination of the cooling to remain substantially constant at a predetermined temperature, thereby preventing the temperature of the battery from increasing to or above a temperature at which launch performance is deteriorated when a vehicle is parked for a predetermined time.

2. Description of the Related Art

Recently, due to various reasons such as environmental problems and increasing oil cost, interest in environmentally friendly vehicles or eco-vehicles, such as electric vehicles, is increasing. An eco-vehicle is driven by actuating a motor using electricity as a power source, and a battery may serve as an alternative to fuel in an eco-vehicle and may be operated together with the motor, an inverter and the like to drive the vehicle.

The performance of the battery is dependent on the temperature of the surrounding environment. In the accompanying drawings, FIG. 1A and FIG. 1B show variations in charging power and discharging power with respect to the temperature of a battery, in which the remaining amount of the state of charge (SOC) is about 60%. When the temperature of the battery has increased to at temperature of about 50° C. or above, the charging power and the discharging power decrease, and the performance of the battery is deteriorated.

In addition, FIG. 2 shows variations in the temperature of a battery during a period of time in which a vehicle is being driven when an exterior temperature is about 42° C. Furthermore, the highest temperature of the battery increases up to about 50° C. during driving. In particular, after the vehicle has been parked for about 2 hours, with an exterior temperature of 42° C., the temperature of the battery is influenced by the exterior temperature and increases up to a temperature of about 53° C. to 54° C., which is higher than directly after the vehicle has stopped driving. Therefore, when the exterior temperature is above a predetermined temperature, the temperature of the battery exceeds about 50° C., that is, a temperature at which the launch performance of the vehicle and the performance of the battery are deteriorated.

In a conventional method of cooling the battery, the intensity of a cooling fan is adjusted depending on temperature variations between cells of a high voltage battery and the highest temperature from among the cells. This approach cools down the battery when the temperature of the battery approaches a predetermined temperature, and a rise in the temperature of the battery that is influenced by the exterior temperature is not considered.

The information disclosed in the Background of the Invention section is only for the enhancement of understanding of the background of the invention, and should not be taken as an acknowledgment or any form of suggestion that this information forms a prior art that would already be known to a person skilled in the art.

### SUMMARY

Accordingly, the present invention provides a cooling control method and system for a battery, in which, when the exterior temperature reaches a predetermined temperatures, cooling control of the battery may be performed by adjusting a cooling fan by detecting a rise in the temperature of the battery caused by the exterior temperature to cause the temperature of the battery upon termination of the cooling to remain at a predetermined temperature, thereby preventing the temperature of the battery from increasing to or above a temperature at which launch performance is deteriorated when a vehicle is parked for a predetermined time.

According to one aspect of the present invention, a cooling control method for a battery may include: measuring, by a controller, an exterior temperature of a vehicle and a temperature of a battery; when the exterior temperature of the vehicle exceeds a first temperature, setting, by the controller, a cooling reference temperature based on the temperature of the battery and the exterior temperature; and adjusting, by the controller, the intensity of a cooling fan based on the set cooling reference temperature to cool the battery and to prevent the temperature of the battery upon termination of cooling from exceeding a second temperature.

The setting of the cooling reference temperature may include setting the cooling reference temperature by detecting the first temperature from a measurement of the exterior temperature and adding the temperature of the battery to the resultant value. The first temperature may be about 40° C., and the second temperature may be about 45° C. When the cooling reference temperature is equal to or higher than the second temperature and is equal to or lower than a third temperature, the intensity of the cooling fan may be adjusted to an intensity level at which the cooling reference temperature is reduced below the second temperature. When the cooling reference temperature exceeds the third temperature, the intensity of the cooling fan may be adjusted to an intensity level at which the cooling reference temperature is reduced below the second temperature.

The cooling control method may also include setting, by the controller, a destination in a navigation device and receiving information about an expected time of arrival at the destination; and when the expected time of arrival is within a reference time, the controller may be configured to determine whether to cool the battery based on a measurement of the exterior temperature.

According to another aspect of the present invention, a cooling control system for a battery may include a controller configured to measure an exterior temperature of a vehicle and a temperature of a battery; to set a cooling reference temperature based on the temperature of the battery and the exterior temperature when the exterior temperature of the vehicle exceeds a first temperature; and controlling the intensity of a cooling fan based on the set cooling reference temperature to cool the battery, wherein the temperature of the battery upon termination of cooling does not exceed a second temperature.

According to a further aspect of the present invention, the controller may be further configured to measure an exterior temperature of a vehicle and a temperature of the battery, set a cooling reference temperature based the exterior temperature and the temperature of the battery when the exterior temperature exceeds a first temperature, and adjust the intensity of a cooling fan based on the set cooling reference temperature so that the temperature of the battery upon termination of cooling does not exceed a second temperature.

According to the present invention as set forth above, since the temperature of the battery is more efficiently controlled by adding the exterior temperature to control input variables, the battery lifespan and output power management may be improved. In particular, when the exterior temperature reaches a predetermined temperature, prior to parking a vehicle, it may be possible to control the temperature of the battery, which would otherwise increase under the influence of the exterior temperature, to prevent the battery temperature from exceeding about 50° C. while the vehicle remains parked for a predetermined time. Thus the performance of the battery may be prevented from deteriorating, and launch performance may be prevented from deteriorating when the vehicle starts up after having been parked.

In addition, since information about arrival of a vehicle at a destination may be used as an input variable, it may be possible to prevent the cooling fan from excessively operating during driving, thereby minimizing noises resulting from the operation of the cooling fan.

### BRIEF DESCRIPTION OF THE DRAWINGS

The above and other objects, features and advantages of the present invention will be more clearly understood from the following detailed description when taken in conjunction with the accompanying drawings, in which:

FIG. 1A and FIG. 1B are exemplary graphs showing variations in charging power and discharging power with respect to the temperature of a battery according to the related art;

FIG. 2 is an exemplary graph showing variations in the temperature of a battery during a period of time in which a vehicle is being driven when the exterior temperature is substantially high according to the related art;

FIG. 3 is an exemplary flowchart showing a cooling control method for a battery according to an exemplary embodiment of the present invention;

FIG. 4 is a flowchart showing control flows of the control method for a battery according to the present invention;

FIG. 5 is an exemplary diagram showing a cooling control system for a battery according to an exemplary embodiment the present invention; and

FIG. 6 is an exemplary diagram illustrating the operation of adjusting the intensity of a cooling fan when the exterior temperature exceeds a predetermined temperature according to an exemplary embodiment of the present invention.

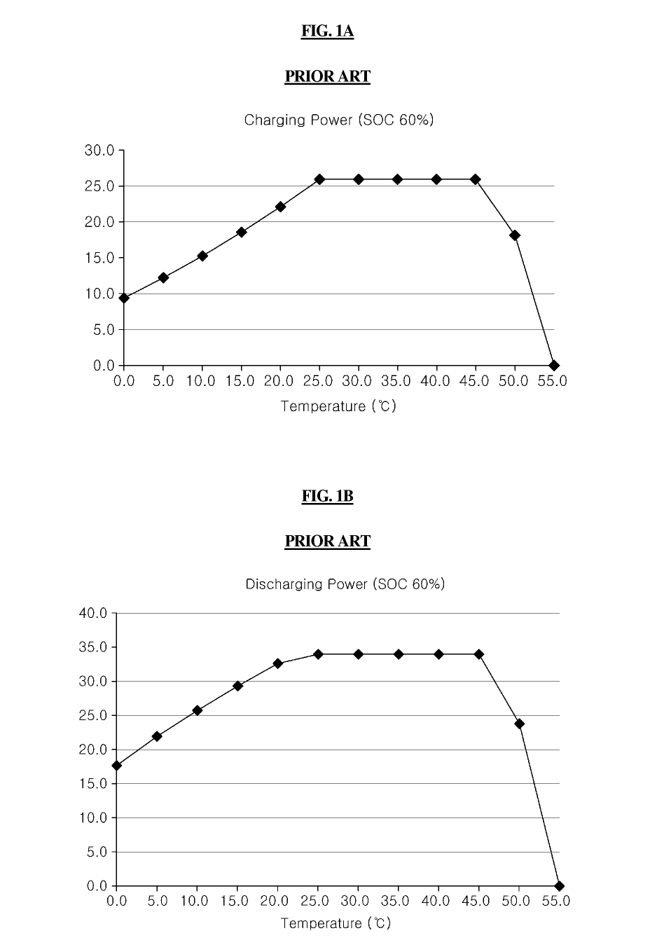

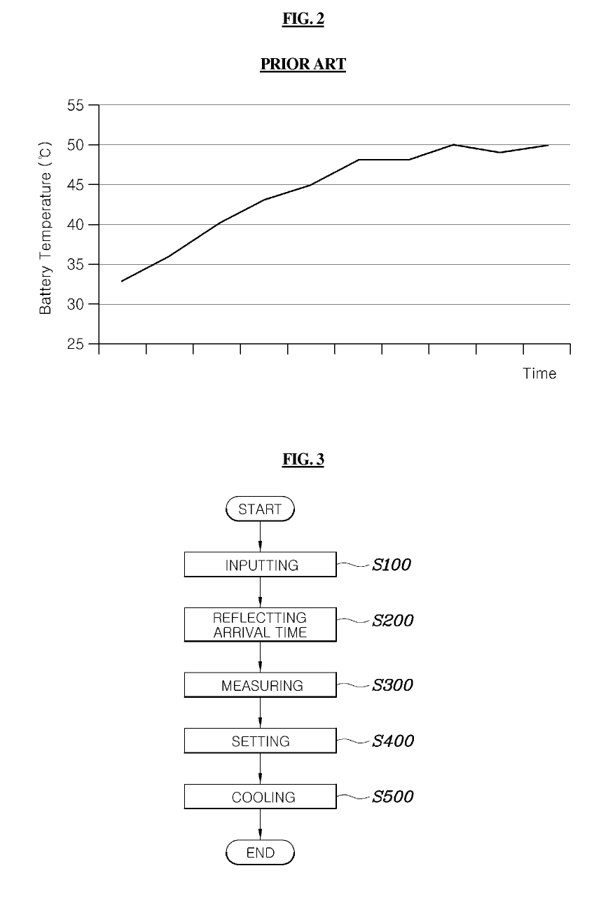

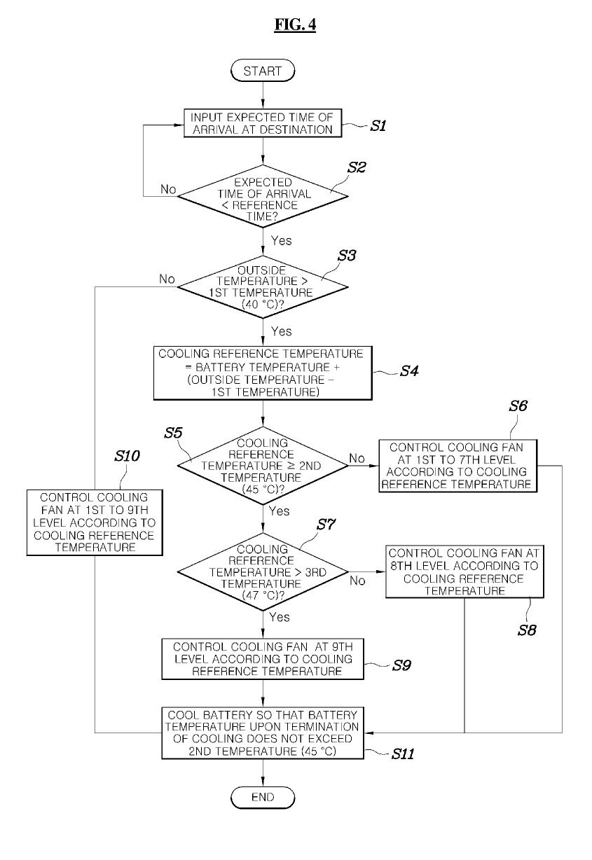

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”

Reference will now be made in greater detail to an exemplary embodiment of the present invention, an example of which is illustrated in the accompanying drawings. Wherever possible, the same reference numerals will be used throughout the drawings and the description to refer to the same or like parts.

FIG. 3 is an exemplary flowchart showing a cooling control method for a battery according to an exemplary embodiment the present invention. The cooling control method for a battery according to the present invention may include a measuring step S300, a setting step S400 and a cooling step S500.

Describing with reference to FIG. 3, the cooling control method for a battery according to the present invention may include measuring (S300), by a controller, the exterior temperature of a vehicle and the temperature of the battery, setting (S400), by the controller, a cooling reference temperature based on the temperature of the battery and the exterior temperature when the exterior temperature of the vehicle exceeds a first temperature, and adjusting (S500), by the controller, the intensity of a cooling fan to cool the battery, based on the set cooling reference temperature to prevent the temperature of the battery upon termination of cooling from exceeding a second temperature. The first temperature may be set to about 40° C., the second temperature may be set to about 45° C., and a third temperature may be set to about 47° C.

When the exterior temperature exceeds the first temperature (e.g., about 40° C.), after a vehicle with the temperature of a battery ranging from about 48° C. to 49° C. has been parked for about 2 hours, the temperature of the battery may increase by about 5° C. due to the exterior temperature and may adjust temperature in the range from about 53° C. to 54° C. In addition, when the exterior temperature exceeds the first temperature (e.g., about 40° C.), after a vehicle with the temperature of the battery of about 45° C. has been parked for about 2 hours, the temperature of the battery may increase by about ° C. due to the exterior temperature and adjusts to about 50° C.

Similarly, when the exterior temperature exceeds the first temperature, the temperature of the battery before parking may increase by a similar level irrespective of how much the temperature has increased. Consequently, when the temperature of the battery is set to not exceed the second temperature (about 45° C.), when the cooling has terminated, the temperature of the battery does not exceed about 50° C. even after the vehicle has been parked for a predetermined time (e.g., about 2 hours). Therefore, the second temperature may be set to about 45° C.

In addition, the cooling reference temperature may be set by detecting the first temperature from a measurement of the exterior temperature and adding the temperature of the battery to the resultant value. This calculation may be expressed by the following formula:

cooling reference temperature=temperature of battery+(outside temperature−first temperature). Equation 1

Furthermore, when the cooling reference temperature is substantially the same as or higher than the second temperature and is substantially the same as or lower than the third temperature, the battery may be cooled by adjusting the intensity of the cooling fan to an intensity at which the cooling reference temperature may be reduced below the second temperature.

The flow rate of air that the cooling fan blows may be adjusted by adjusting the setting of the intensity of the cooling fan based on the speed of the vehicle and the cooling reference temperature. As shown in FIG. 4, the intensity of the cooling fan may be set in the range from first to ninth intensity levels. The number of the intensity levels is given merely for illustrative purposes, but may be variously adjusted.

Referring to FIG. 6, when the cooling reference temperature is substantially the same as or higher than the second temperature (e.g., about 45° C.), and is substantially the same as or lower than the third temperature (e.g., about 47° C.), the battery may be cooled by adjusting the intensity of the cooling fan to the eighth intensity level that is one level below the highest intensity level of the cooling fan.

In addition, when the cooling reference temperature exceeds the third temperature, the battery may be cooled by adjusting the intensity of the cooling fan to the intensity level at which the cooling reference temperature may be reduced below the second temperature. In other words, referring to FIG. 6, when the cooling reference temperature exceeds the third temperature (about 47° C.), the battery may be cooled by adjusting the intensity of the cooling fan to the ninth intensity level which is the highest intensity level of the cooling fan.

When the outside temperature of the vehicle exceeds the first temperature (about 40° C.), the temperature of the battery may increase by less than about 5° C. even when the exterior temperature may increase by about 5° C. Thus, when the exterior temperature has increased by about 1° C., it may be possible to sufficiently cool the battery by further reducing the temperature of the battery by about 1° C.

For example, when the temperature of the battery before parking is about 45° C. and the exterior temperature is about 42° C., the cooling reference temperature may be set to about 47° C. based on equation 1 with which the cooling reference temperature may be calculated. When the vehicle is parked for a predetermined time (e.g., about 2 hours), the temperature of the battery may increase to about 50° C. due to the influence of the exterior temperature. The cooling of the battery may be performed by setting the intensity of the cooling fan to the eighth intensity level which corresponds to about 47° C. before parking by referring to the setting of the intensity levels of the cooling fan, as shown in FIG. 6.

When the intensity of the cooling fan is set to the eighth intensity level, cooling of about 1° C. to 3° C. may be performed under the condition that the exterior temperature exceeds the first temperature (e.g., about 40° C.). Consequently, the temperature of the battery upon completion of the cooling may become lower than about 45° C. by about 1° C. to 3° C. After parking, when the temperature increases by 5° C., the temperature of the battery may not increase above about 50° C. This consequently prevents the performance of the battery from deteriorating, and prevents launch performance from deteriorating when the vehicle stalls up after having been parked.

In another example, when the temperature of the battery before parking is about 48° C. and the exterior temperature is about 42° C., the cooling reference temperature may be set to about 50° C. based on equation 1 with which the cooling reference temperature may be calculated. When the vehicle is parked for a long time (e.g., about 2 hours) under these conditions, the temperature of the battery may increase to about 53° C. due to the exterior temperature. The cooling of the battery may be performed by setting the intensity of the cooling fan to the ninth intensity level which corresponds to about 50° C. before parking by referring to the setting of the intensity levels of the cooling fan, as shown in FIG. 6.

When the intensity of the cooling fan is adjusted from among the first to ninth intensity levels, the battery may be cooled by about 4° C. to 5° C. when the exterior temperature exceeds the first temperature (e.g., about 40° C.). Thus, the temperature of the battery upon termination of the cooling may decrease by about 4° C. to 5° C. from about 48° C. When the exterior temperature increases by about 5° C. after the vehicle was parked, the increased temperature of the battery may not exceed about 50° C. This consequently prevents the performance of the battery from deteriorating, and prevents the launch performance from deteriorating when the vehicle starts up after having been parked.

In addition, as shown in FIG. 3 and FIG. 4, the cooling control method for a battery according to the present invention may further include inputting (S100), by the controller, a destination to a navigation device and receiving information regarding an expected time of arrival at the destination and determining (S200), by the controller, whether to cool the battery based on a measurement of the exterior temperature when the expected time of arrival is within a reference time. The reference time may be about 30 minutes, and the information regarding the expected time of arrival received from the navigation device may be transmitted to the controller using controller area network (CAN) communication.

In other words, the information regarding the expected time of arrival provided from the navigation device by detecting the expected time of arrival from the present time may be received by the controller, and when the information regarding the expected time of arrival is substantially the same as or less than about 30 minutes, the controller may be configured to cool the battery based on the exterior air.

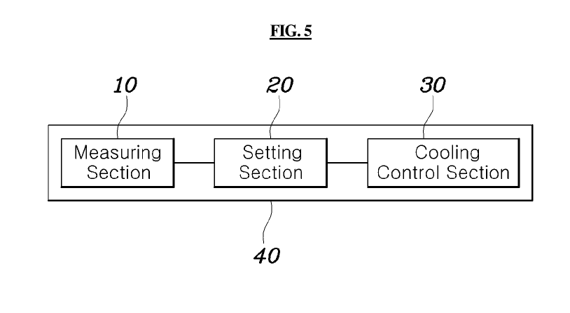

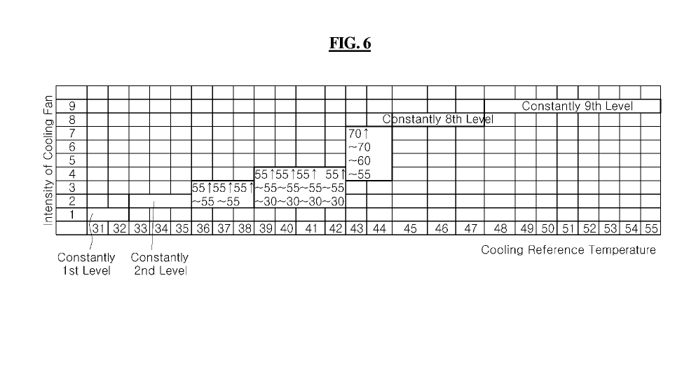

FIG. 5 is an exemplary diagram showing a cooling control system for a battery according to an exemplary embodiment of the present invention. Referring to FIG. 5, the cooling control system for a battery according to the present invention may include a plurality of units operated by a controller 40 having a processor and a memory. The plurality of units may include a measuring unit 10 configured to measure the exterior temperature of a vehicle and the temperature of the battery, a setting unit 20 configured to set a cooling reference temperature based on the temperature of the battery and the exterior temperature when the exterior temperature exceeds a first temperature, and a cooling control unit 30 configured to cool the battery by adjusting the intensity of a cooling fan based on the set cooling reference temperature to prevent the temperature of the battery upon termination of cooling from exceeding a second temperature.

With reference to FIG. 4, a description will be given of the sequence of the cooling control method for a battery according to an exemplary embodiment of the present invention.

When a vehicle is being driven, information regarding expected time of arrival that indicates a time left before arrival at a destination may be received at a controller from a navigation device (S1). The controller may be configured to determine whether the information regarding expected time of arrival is substantially the same as or less than about 30 minutes (S2), and when the controller determines that the information regarding expected time of arrival is substantially the same as or less than about 30 minutes, the process may continue to step S3.

At step S3, the controller may be configured to compare an exterior temperature with a first temperature, and when the exterior temperature is substantially the same as or lower than the first temperature (e.g., about 40° C.), the process may continue to step S10. At step S10, the controller may be configured to operate the intensity of a cooling fan based on the temperature of the battery (e.g., between a first and a ninth intensity level). The controller may be configured to cool the battery by adjusting the intensity of the cooling fan based on the temperature of the battery.

In addition, when the exterior temperature exceeds the first temperature (e.g., about 40° C.), as a result of comparing the exterior temperature with the first temperature, the process may continue to step S4, when a cooling reference temperature may be set. Then, at step S5, when the set cooling reference temperature is below a second temperature (e.g., about 45° C.), the process proceeds to step S6, when the controller may be configured to cool the battery by controlling the flow rate of air by adjusting the intensity of a cooling fan between the first to seventh intensity levels referring to the setting of the intensity levels of the cooling fan, as shown in FIG. 6.

Additionally, at S5, when the set cooling reference temperature is substantially the same as or higher than the second temperature (e.g., about 45° C.), the process may continue to step S7, when the controller may be configured to compare the set cooling reference temperature with a third temperature. As a result of the comparison, when the set cooling reference temperature is substantially the same as or lower than the third temperature (e.g., about 47° C.), the process may continue to step S8, where the controller may be configured too cool battery by about 1° C. to 3° C. by controlling the cooling fan at the eighth intensity level according to the setting of the intensity levels of the cooling fan, as shown in FIG. 6.

On the other hand, when the set cooling reference temperature exceeds the third temperature, (e.g., about 47° C.), the process may continue to step S9, when the controller may be configured to cool battery by about 4° C. or more by controlling the cooling fan at the ninth intensity level according to the setting of the intensity levels of the cooling fan, as shown in FIG. 6. After the cooling, steps S8, S6 and S10 as well as step S9 may continue to step S11, where the controller may be configured to cool the battery to prevent the temperature of the battery upon termination of cooling from exceeding about 45° C.

As set forth above, the present invention may increase the efficiency of managing the temperature of the battery by adding the exterior temperature to control input variables, and may thus increase battery lifespan and improve output power management. In particular, when the exterior temperature is above a predetermined temperature, prior to parking a vehicle, it may be possible to control the temperature of the battery, which would otherwise increase due to the exterior temperature, so as not to exceed about 50° C. while the vehicle remains parked for a predetermined time. This consequently prevents the performance of the battery from deteriorating, and prevents launch performance from deteriorating when the vehicle starts up after having been parked.

In addition, since information about the arrival of the vehicle at a destination may be used as an input variable, it may be possible to prevent the cooling fan from excessively operating while a vehicle is driven, thereby minimizing noises resulting from the operation of the cooling fan.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. A cooling control method for a battery comprising:
measuring, by a controller, an exterior temperature of a vehicle;
measuring, by the controller, a temperature of the battery;
setting, by the controller, a cooling reference temperature based on the measured battery and exterior temperatures, when the exterior temperature of the vehicle exceeds a first temperature; and
cooling, by the controller, the battery by adjusting an intensity of a cooling fan based on the set cooling reference temperature to prevent the temperature of the battery upon termination of cooling from exceeding a second temperature.

2. The cooling control method of claim 1, wherein the setting the cooling reference temperature include:
setting, by the controller, the cooling reference temperature by detecting the first temperature from a measurement of the exterior temperature and adding the temperature of the battery to a resultant value.

3. The cooling control method of claim 1, wherein the first temperature is about 40° C. and the second temperature is about 45° C.

4. The cooling control method of claim 2, further comprising:
cooling, by the controller, the battery by adjusting the intensity of the cooling fan at an intensity level at which the cooling reference temperature is reduced below the second temperature, when the cooling reference temperature is equal to or higher than the second temperature and is equal to or lower than the third temperature.

5. The cooling control method of claim 2, further comprising:
cooling, by the controller, the battery by adjusting the intensity of the cooling fan at an intensity level at which the cooling reference temperature is reduce below the second temperature, when the cooling reference temperature exceeds the third temperature.

6. The cooling control method of claim 1, further comprising:
setting, by the controller, a destination in a navigation device;
receiving, at the controller, information regarding an expected time of arrival at the destination; and
determining, by the controller, whether to cool the battery based on a measurement of the exterior temperature, when the expected time of arrival is within a reference time.

7. A cooling control system for a battery comprising:
a controller configured to:
measure an exterior temperature of a vehicle;
measure a temperature of a battery;
set a cooling reference temperature based on the temperature of the battery and the exterior temperature when the exterior temperature of the vehicle exceeds a first temperature; and
cool the battery by adjusting an intensity of a cooling fan based on the set cooling reference temperature to prevent the temperature of the battery upon termination of cooling from exceeding a second temperature.

8. The system of claim 7, wherein the controller is further configured to:
set the cooling reference temperature by detecting the first temperature from a measurement of the exterior temperature and adding the temperature of the battery to a resultant value.

9. The system of claim 7, wherein the first temperature is about 40° C. and the second temperature is about 45° C.

10. The system of claim 8, wherein the controller is further configured to:
cool the battery by adjusting the intensity of the cooling fan at an intensity level at which the cooling reference temperature is reduced below the second temperature, when the cooling reference temperature is equal to or higher than the second temperature and is equal to or lower than the third temperature.

11. The system of claim 8, wherein the controller is further configured to:
cool the battery by adjusting the intensity of the cooling fan at an intensity level at which the cooling reference temperature is reduce below the second temperature, when the cooling reference temperature exceeds the third temperature.

12. The system of claim 7, wherein the controller is further configured to:
set a destination in a navigation device;
receive information regarding an expected time of arrival at the destination; and
determine whether to cool the battery based on a measurement of the exterior temperature, when the expected time of arrival is within a reference time.

13. A non-transitory computer readable medium containing program instructions executed by a processor or controller, the computer readable medium comprising:
program instructions that measure an exterior temperature of a vehicle;
program instructions that measure a temperature of a battery;
program instructions that set a cooling reference temperature based on the temperature of the battery and the exterior temperature when the exterior temperature of the vehicle exceeds a first temperature; and
program instructions that cool the battery by adjusting an intensity of a cooling fan based on the set cooling reference temperature to prevent the temperature of the battery upon termination of cooling from exceeding a second temperature.

14. The non-transitory computer medium of claim 13, further comprising:
program instructions that set the cooling reference temperature by detecting the first temperature from a measurement of the exterior temperature and adding the temperature of the battery to a resultant value.

15. The non-transitory computer medium of claim 13, wherein the first temperature is about 40° C. and the second temperature is about 45° C.

16. The non-transitory computer readable medium of claim 14, further comprising:
program instruction that cool the battery by adjusting the intensity of the cooling fan at an intensity level at which the cooling reference temperature is reduced below the second temperature, when the cooling reference temperature is equal to or higher than the second temperature and is equal to or lower than the third temperature.

17. The non-transitory computer readable medium of claim 14, further comprising:
program instructions that cool the battery by adjusting the intensity of the cooling fan at an intensity level at which the cooling reference temperature is reduce below the second temperature, when the cooling reference temperature exceeds the third temperature.

18. The non-transitory computer readable medium of claim 13, further comprising:
program instructions that set a destination in a navigation device;
program instructions that receive information regarding an expected time of arrival at the destination; and
program instructions that determine whether to cool the battery based on a measurement of the exterior temperature, when the expected time of arrival is within a reference time.
